(19) United States
(12) Patent Application Publication
(10) Pub. No.: US 2007/0033856 A1
(43) Pub. Date: Feb. 15, 2007

(54) System, method and apparatus for storing fishing rods and reels

(76) Inventor: Geordie Jenner, St. Petersburg, FL (US)

Correspondence Address: LARSON AND LARSON, 11199 69TH STREET NORTH, LARGO, FL, 33773, US

(21) Appl. No.: 11/202,495

(22) Filed: Aug. 12, 2005

(51) Int. Cl. A01K 97/08

(52) U.S. Cl. 43/26; 43/21.2

(57) ABSTRACT

A fishing pole storage system has one or more storage compartments for storing fishing poles. The storage compartments retract and hide within a base cabinet and rise out of the base cabinet to allow access the fishing poles. The storage compartment(s) is lifted out of the base cabinet by a motor driven system using gears, pulleys or hydraulics.

### BACKGROUND OF THE INVENTION

1. Field of the Invention

This invention relates to the field of storing fishing rods and reels or other long devices, and more particularly, to a system where the storage compartment elevates out of a compartment.

2. Description of the Related Art

Storage of fishing rods and reels requires substantial length due to the fact that fishing rods are long. Often, fishing rods and reels are stored on pegs mounted in a wall, utilizing substantial wall space and, in living spaces such as condominiums, affecting the aesthetics of the room in which they are stored. A storage cabinet for storing fishing rods and reels would need to be very large and, although not being very deep, they would require substantial wall space. Furthermore, a cabinet that is not very deep has reduced stability and tends to fall forward when doors or drawers on its face are opened.

U.S. Pat. No. 5,096,275 to Pappas addresses the problem of storage of various small items on hooks and in boxes, but is not suited to hold fishing rods and reels. U.S. Pat. No. 6,612,670 to Liu addresses the problem of storing and elevating a screen and is hereby incorporated by reference.

What is needed is a system that will efficiently store a number of fishing rods and reels in an orderly fashion while not detracting from the aesthetics of a living space.

### SUMMARY OF THE INVENTION

In one embodiment, a system for storing fishing poles is disclosed including a base housing with a front, rear, top with one or more openings, bottom and two side walls. At least one fishing pole storage compartment is housed within the base housing and adapted to lift out of the base housing through the one or more openings. The at least one fishing pole storage compartment has a top surface, a back surface, at least two side surfaces and a plurality of hooks mounted to a front side of the back surface for holding fishing poles. There is a mechanism to raise and lower the at least one fishing pole storage compartment out of the base housing through the one or more holes.

In another embodiment, a method of storing fishing poles is disclosed including raising a fishing pole storage compartment configured within a base housing, the fishing pole storage compartment lifts out of the base housing through one or more openings in a top of the base housing. The fishing pole storage compartment has a top surface, a back surface, at least two side surfaces and a plurality of hooks mounted to a front side of the back surface for holding fishing poles and the base housing has a front, rear, top, bottom and two side walls. The fishing pole is hung on the plurality of hooks affixed to the back surface of the fishing pole storage compartment and the fishing pole storage compartment is lowered into the base housing.

In another embodiment, an apparatus for storing fishing poles is disclosed including a base housing with a front, rear, top with at least one opening, bottom and two side walls. At least one fishing pole storage compartment is configured within the base housing and adapted to lift out of the base housing through the at least one opening. The at least one fishing pole storage compartment has a top surface, a back surface, at least two side surfaces and a plurality of hooks mounted to a front side of the back surface for holding fishing poles. There is a mechanism to raise and lower the at least one fishing pole storage compartment.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a view of a system of a first embodiment of the present invention.

FIG. 2 illustrates a detail view of the raising and lowering system of a first embodiment of the present invention.

FIG. 3 illustrates a view of a system of a second embodiment of the present invention.

FIG. 4 illustrates a detail view of the raising and lowering system of a second embodiment of the present invention.

FIG. 5 illustrates a view of a system of a third embodiment of the present invention.

FIG. 6 illustrates a view of an up/down switch of all embodiments of the present invention.

FIG. 7 illustrates a view of a system of a fourth embodiment of the present invention.

FIG. 8 illustrates a detail view of the raising and lowering system of a fourth embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

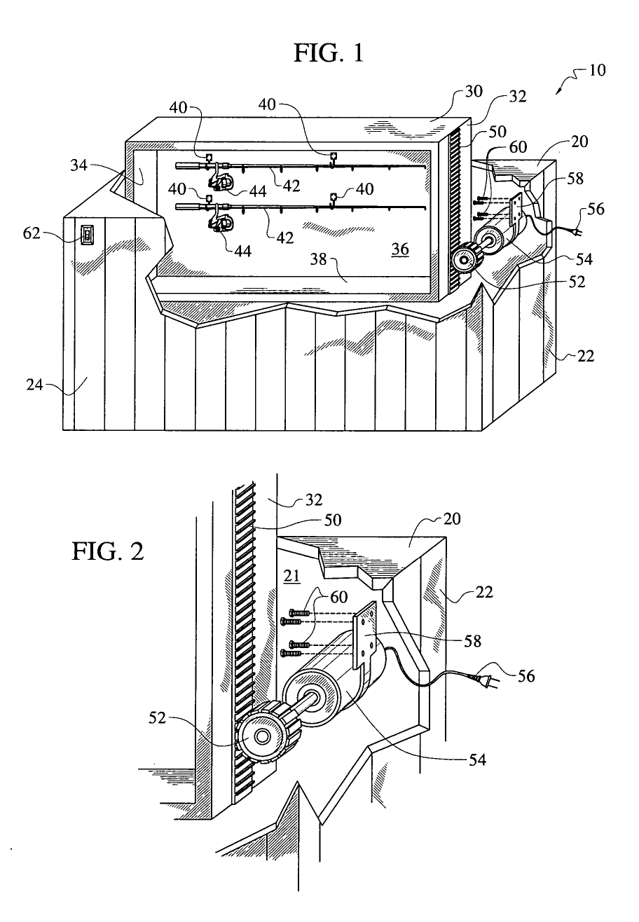

Referring to FIG. 1, a view of a system for storing fishing poles 10 of a first embodiment of the present invention is described. Although most useful for storing fishing rods and reels, the present invention can be adapted to store other objects of considerable length such as oars, shotguns and the like.

The base housing has a front surface 24, side surfaces 22 and a top surface 20. The bottom and back surface are not visible. In some embodiments, the base housing is made of decorative material such as wood or a wood-based material with a wood veneer or decorative plastic surface. Housed within the base housing is a fishing pole storage compartment with sides 32/34, back 36, bottom 38 and top 30. Although the fishing pole storage compartment can be made from most any material, in some embodiments, the fishing pole storage compartment is made of decorative material such as wood or a wood-based material with a wood veneer, painted surface or decorative plastic surface. In some embodiments, the top surface 30 is decorated to match the top surface 20 of the base housing, so that when the fishing pole storage compartment is lowered and its top surface 30 is flush with the top surface 20 of the base housing, the two match. Mounted on the back surface 36 of the fishing pole storage compartment is a plurality of hooks 40 configured to hold a plurality of fishing poles 42 and, in some embodiments fishing reels 44. These hooks 40 may be standard hooks or formed of slots in wood.

The fishing pole storage compartment fits within the base housing and there is a hole in the top of the base housing large enough for the fishing pole storage compartment to lift out of the base housing. To facilitate the lifting, a rack 50 is mounted to one or both sides 32/34 of the fishing pole storage compartment and the rack engages with a gear 52 that is driven by a motor 54. The motor is mounted to a surface of the base unit, in this example it is mounted to the side 22 with a bracket 58 and screws 60. Power is supplied by a power cord 56 and the motor is controlled by a switch 62, the switch having a momentary contact to raise the fishing pole storage compartment and a momentary contact to lower the fishing pole storage compartment.

Referring to FIG. 2, a detail view of the raising and lowering system of a first embodiment of the present invention is described. In this example, the rack 50 is mounted to the right side 32 of the fishing pole storage compartment; the motor 54 is mounted to the right side 22 of the base housing with a mounting plate 58 and screws 60 and connected to a source of electricity by a power cable 56. When energized, the motor 54 turns the gear 52 which engages with the rack 50, raising or lowering the fishing pole storage compartment, depending on which way the motor turns. The top 20 and back 21 of the base housing are visible.

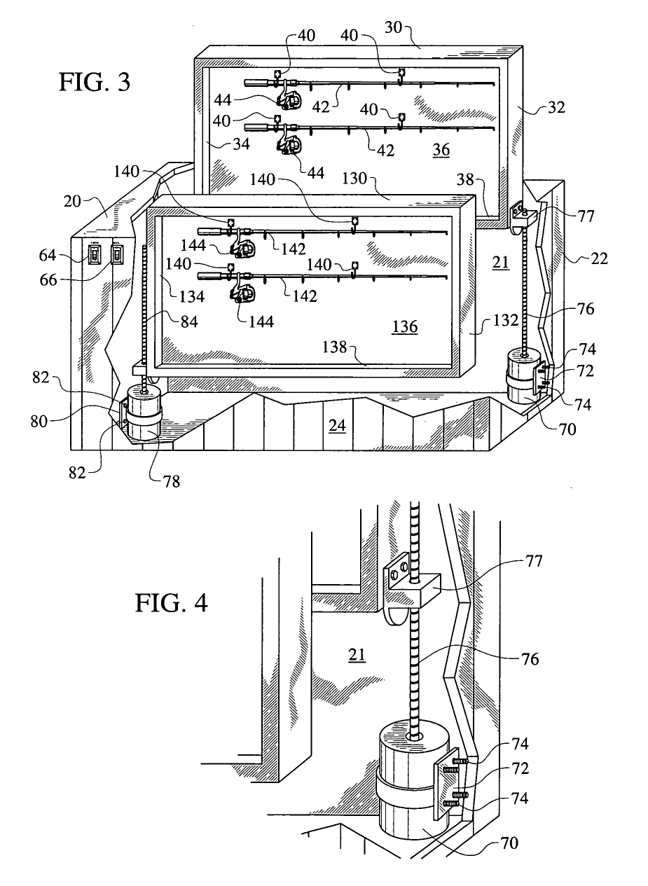

Referring to FIG. 3, a view of a system for storing fishing poles of a second embodiment of the present invention is described. The base housing has a front surface 24, side surfaces 22, a back surface 21 and a top surface 20. In some embodiments, the base housing is made of decorative material such as wood or a wood-based material with a wood veneer or decorative plastic surface. Housed within the base housing are two fishing pole storage compartments with sides 32/132/34/134, backs 36/136, bottoms 38/138 and tops 30/130. In some embodiments, the fishing pole storage compartments are made of decorative material such as wood or a wood-based material with a wood veneer or decorative plastic surface. In some embodiments, the top surfaces 30/130 are decorated to match the top surface 20 of the base housing, so that when the fishing pole storage compartment is lowered and its top surfaces 30/130 are flush with the top surface 20 of the base housing, they match. Mounted on the back surface 36/136 of the fishing pole storage compartment is a plurality of hooks 40/140 configured to hold a plurality of fishing poles 42/142 and, in some embodiments fishing reels 44/144. These hooks 40/140 may be standard hooks or formed of slots in wood.

The fishing pole storage compartments fit within the base housing and there are holes in the top of the base housing large enough for the fishing pole storage compartments to lift out of the base housing. To facilitate the lifting, a worm drive is mounted to one or both sides 32/132/34/134 of both fishing pole storage compartments. The worm drive consists of threaded shafts 76/84 threaded through a threaded hole in brackets 77 that are attached to the sides of the fishing pole storage compartment. An end of each of the threaded shafts is coupled to a motor 70/78. The motors 70/78 are mounted to a side 22 of the base unit, in this example it is mounted to the side 22 with a bracket 72/80 and screws 74/82. The motors are controlled by two switches, one for the front fishing pole storage compartment 64 and one for the back fishing pole storage compartment 66, the switched having a momentary contact to raise the fishing pole storage compartments and a momentary contact to lower the fishing pole storage compartments.

Referring to FIG. 4 and FIG. 3, a detail view of the raising and lowering system of a second embodiment of the present invention is described. The worm drive consists of a threaded shaft 76 threaded through a threaded hole in a bracket 77 that is attached to a side of the fishing pole storage compartment. An end of the threaded shaft 76 is coupled to a motor 70. The motor 70 is mounted to a side 22 of the base unit, in this example it is mounted to the side 22 with a bracket 72 and screws 74. The motor is controlled by two switches, one for the front fishing pole storage compartment 64 and one for the back fishing pole storage compartment 66, the switches have a momentary contact to raise the fishing pole storage compartments and a momentary contact to lower the fishing pole storage compartments. In other embodiments, the motor 70 is mounted to the bottom, front or back of the base housing. The back 21 of the base housing is visible.

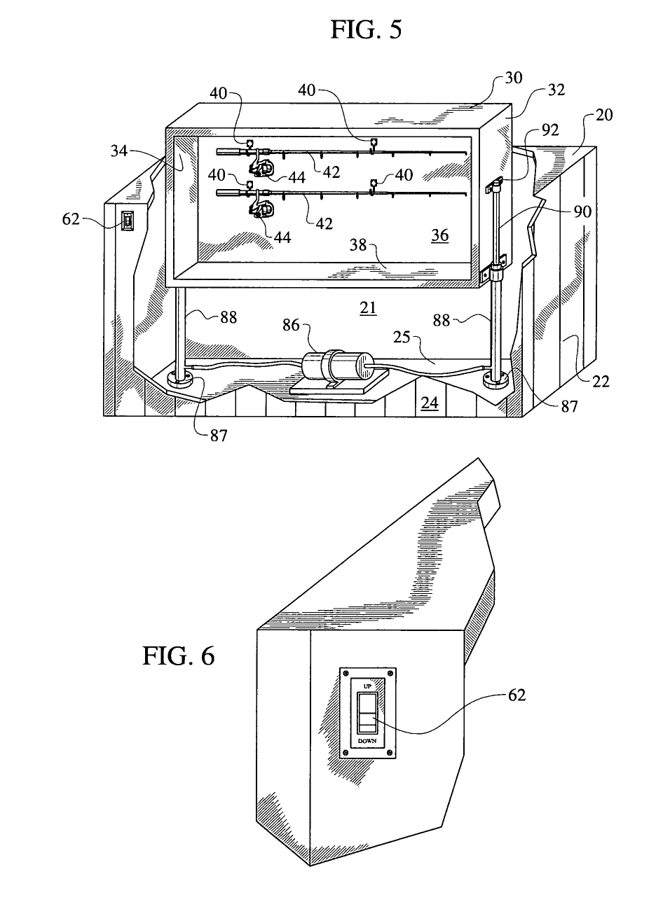

Referring to FIG. 5, a view of a system for storing fishing poles of a third embodiment of the present invention is described. The base housing has a front surface 24, side surfaces 22, a back surface 21, a bottom surface 25 and a top surface 20. In some embodiments, the base housing is made of decorative material such as wood or a wood-based material with a wood veneer or decorative plastic surface. Housed within the base housing is a fishing pole storage compartment with sides 32/34, back 36, bottom 38 and top 30. In some embodiments, the fishing pole storage compartment is made of decorative material such as wood or a wood-based material with a wood veneer or decorative plastic surface. In some embodiments, the top surface of the fishing pole storage compartment 30 is decorated to match the top surface 20 of the base housing, so that when the fishing pole storage compartment is lowered and its top surface 30 is flush with the top surface 20 of the base housing, they match. Mounted on the back surface 36 of the fishing pole storage compartment is a plurality of hooks 40 configured to hold a plurality of fishing poles 42 and, in some embodiments, fishing reels 44. These hooks 40 may be standard hooks or formed of slots in wood.

The fishing pole storage compartment fits within the base housing and there is a hole in the top of the base housing large enough for the fishing pole storage compartment to lift out of the base housing. To facilitate the lifting, one or more hydraulic cylinders 88 are mounted to the bottom of the base housing 25 and hydraulic pistons 90 of the hydraulic cylinders are attached to the side 32/34 of the fishing pole storage compartment by brackets 92. A hydraulic pump 86 generates hydraulic pressure, causing the pistons 90 to rise out of the cylinders 88, thereby lifting the fishing pole storage compartment, or lowering by releasing pressure. The hydraulic pump is controlled by a switch 62, the switch having a momentary contact to raise the fishing pole storage compartment and a momentary contact to lower the fishing pole storage compartment.

Referring to FIG. 6, a view of an up/down switch of all embodiments of the present invention is described. The switch 62 has an up position and a down position. In some embodiments, the up and down positions are momentary contact and in some embodiments pressing the up makes contact, lifting the fishing pole storage compartment until it reaches a limit where a limit switch stops the motor or pump from lifting the fishing pole storage compartment further. Pressing the down makes contact, lowering the fishing pole storage compartment until it reaches a lower limit where a limit switch stops the motor or pump. In some embodiments, there is a separate switch for up and one for down.

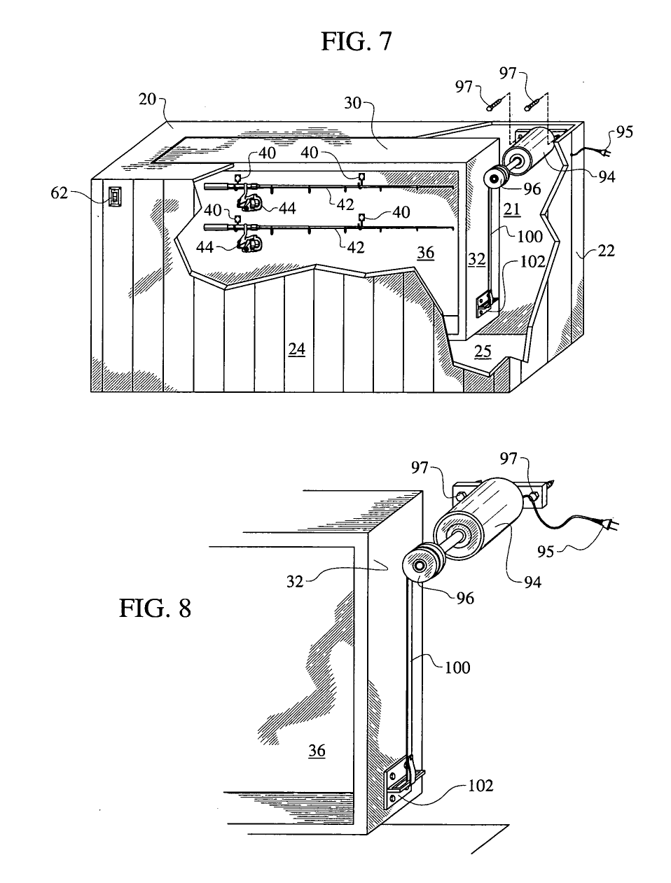

Referring to FIG. 7, a view of a system for storing fishing poles of a fourth embodiment of the present invention is described. The base housing has a front surface 24, side surfaces 22, a back surface 21, a bottom surface 25 and a top surface 20. In some embodiments, the base housing is made of decorative material such as wood or a wood-based material with a wood veneer or decorative plastic surface. Housed within the base housing is a fishing pole storage compartment shown in the lowered position with sides 32, back 36 and top 30. In some embodiments, the fishing pole storage compartment is made of decorative material such as wood or a wood-based material with a wood veneer or decorative plastic surface. In some embodiments, the top surface 30 is decorated to match the top surface 20 of the base housing, so that when the fishing pole storage compartment is lowered as shown and its top surface 30 is flush with the top surface 20 of the base housing, they match. Mounted on the back surface 36 of the fishing pole storage compartment is a plurality of hooks 40 configured to hold a plurality of fishing poles 42 and, in some embodiments, fishing reels 44. In some embodiments, the back surface 36 of the fishing pole storage compartment is covered with a decorative material such as cloth or felt. The hooks 40 may be standard hooks or formed of slots in wood.

The fishing pole storage compartment fits within the base housing and there is a hole in the top of the base housing large enough for the fishing pole storage compartment to lift out of the base housing. To facilitate lifting and lowering, one or more motors 94 are mounted to the back surface 21 of the base housing of the fishing pole storage compartment by screws 97. Each motor(s) 94 has a pulley 96 with a rope or wire 100 wrapped around the pulley 96. An end of the rope or wire 100 is attached to a bracket 102 so that as the motor(s) 94 turns, the rope or wire 100 wraps around the pulley 96 thereby lifting the fishing pole storage compartment, or lowering by an opposing rotation. Power is provided to the motor(s) by a power cable 95. The motor(s) are controlled by a switch 62, the switch having a momentary contact to raise the fishing pole storage compartment and a momentary contact to lower the fishing pole storage compartment.

Referring to FIG. 8 and FIG. 7, a detail view of the raising and lowering system of a fourth embodiment of the present invention is described. The motor 94 is held against the back surface 21 by fasteners 97, though in some embodiments the motor is mounted on another surface of the base housing. A wire or rope 100 is attached to a spool 96 and wraps or unwraps from the spool 96 depending on the rotational direction of the motor 94. An end of the wire or rope 100 is attached to a bracket 102 affixed to the side 32 of the fishing pole storage compartment so that as the wire or rope 100 wraps or unwraps around the spool 96, the fishing pole storage compartment lifts or lowers out of/into the base housing. The motor 94 receives electrical power from a power cord 95. The back of the fishing pole storage compartment 36 is visible.

Although the preceding descriptions have motor-based mechanisms for lifting the fishing pole storage compartment out of the base housing, in some embodiments, a manual method is provided using a crank or other lever mechanism to raise and lower the fishing pole storage compartment. Furthermore, the fishing pole storage compartment is lifted using magnetism with either two electromagnets or an electro-magnet and a permanent magnet pushing away from each other when energized.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for storing fishing poles, the system comprising:
a base housing having a front, rear, top, bottom and two side walls, the top having one or more openings;
at least one fishing pole storage compartment configured within the base housing, the at least one fishing pole storage compartment adapted to lift out of the base housing through the one or more openings, the at least one fishing pole storage compartment having a top surface, a back surface, at least two side surfaces and a plurality of hooks mounted to a front side of the back surface for holding fishing poles; and
a means to raise and lower the at least one fishing pole storage compartment.

2. The system for storing fishing poles of claim 1, wherein the means to raise and lower is at least two hydraulic cylinders.

3. The system for storing fishing poles of claim 1, wherein the means to raise and lower is selected from the group comprising motor driven worm gears, motor driven rack and pinion gears, and motor driven cable and pulley.

4. The system for storing fishing poles of claim 1, wherein the top surfaces of the at least one fishing pole storage compartment form a substantially continuous top surface with the top of the base housing when the at least one fishing pole storage compartment is in a lowered position.

5. The system for storing fishing poles of claim 1, further comprising a switch configured to control the means to raise and lower.

6. The system for storing fishing poles of claim 1, wherein the plurality of hooks is adapted to hold the fishing poles in a substantially horizontal orientation.

7. The system for storing fishing poles of claim 1, further comprising a plurality of fishing reels attached to the fishing poles.

8. The system for storing fishing poles of claim 1, wherein the front, top and two sides of the base housing and the top surface of the fishing pole storage compartment are made of a material selected from the group consisting of wood, plywood, pressboard and particle board and the exposed surface of the material is finished with a finishing selected from the group consisting of Formica, wood veneer, stain, varnish and polyurethane.

9. A method for storing fishing poles comprising:
raising a fishing pole storage compartment configured within a base housing, the fishing pole storage compartment adapted to lift out of the base housing through one or more openings in a top of the base housing, the fishing pole storage compartment having a top surface, a back surface, at least two side surfaces and a plurality of hooks mounted to a front side of the back surface for holding fishing poles; the base housing having a front, rear, bottom and two side walls;
hanging the fishing pole on a plurality of hooks affixed to the back surface of the fishing pole storage compartment; and
lowering the fishing pole storage compartment.

10. The method for storing fishing poles of claim 9, wherein the raising and lowering is performed by at least two hydraulic cylinders.

11. The method for storing fishing poles of claim 9, wherein the raising and lowering is performed by a device selected from the group comprising motor driven worm gears, motor driven rack and pinion gears, and motor driven cable and pulley and the device is controlled by a switch.

12. The method for storing fishing poles of claim 9, wherein the top surfaces of the at least one fishing pole storage compartment form a substantially continuous top surface with the top of the base housing when the at least one fishing pole storage compartment is in a lowered position.

13. The method for storing fishing poles of claim 9, further comprising a switch configured to control the raising and lowering.

14. The method for storing fishing poles of claim 9, wherein the plurality of hooks is adapted to hold the fishing poles in a substantially horizontal orientation.

15. The system for storing fishing poles of claim 9, further comprising a plurality of fishing reels attached to the fishing poles.

16. An apparatus for storing fishing poles, the apparatus comprising:
a base housing means having a front, rear, top, bottom and two side walls, the top having at least one opening;
at least one fishing pole storage means configured within the base housing, the at least one fishing pole storage means adapted to lift out of the base housing means through the at least one opening, the at least one fishing pole storage means having a top surface, a back surface, at least two side surfaces and a plurality of hooks mounted to a front side of the back surface for holding fishing poles; and
a means to raise and lower the at least one fishing pole storage means.

17. The system for storing fishing poles of claim 16, wherein the means to raise and lower is at least two hydraulic cylinders.

18. The system for storing fishing poles of claim 16, wherein the means to raise and lower is selected from the group comprising motor driven worm gears, motor driven rack and pinion gears, and motor driven cable and pulley.

19. The system for storing fishing poles of claim 16, wherein the top surfaces of the at least one fishing pole storage means form a substantially continuous top surface with the top of the base housing means when the at least one fishing pole storage compartment is in the lowered position.

20. The system for storing fishing poles of claim 16, further comprising a switch configured to control the means to raise and lower.

21. The system for storing fishing poles of claim 16, wherein the plurality of hooks is adapted to hold the fishing poles in a substantially horizontal orientation.
